(19) United States
(12) Patent Application Publication
(10) Pub. No.: US 2014/0288949 A1
(43) Pub. Date: Sep. 25, 2014

(54) Telephonic Device Payment Processing

(71) Applicant: Ersno Eromo, Ghent, NY (US)

(72) Inventor: Ersno Eromo, Ghent, NY (US)

(21) Appl. No.: 14/219,982

(22) Filed: Mar. 19, 2014

Related U.S. Application Data
(60) Provisional application No. 61/803,823, filed on Mar. 21, 2013.

(51) Int. Cl. G06Q 20/16; G06Q 20/02; G06Q 20/10; G06Q 50/22

(52) U.S. Cl. CPC G06Q 20/16; G06Q 40/08; G06Q 50/22; G06Q 20/02; G06Q 20/102
USPC 705/2

(57) ABSTRACT

A solution for managing payment of a transaction, such as a medical transaction, is provided. Telephone identification information, such as a mobile telephone number, is used to initiate a partial payment for the transaction. Information regarding the transaction can be provided to the corresponding mobile device for confirmation. Once confirmed, the partial payment can be processed.

### REFERENCE TO RELATED APPLICATIONS

The current application claims the benefit of U.S. Provisional Application No. 61/803,823, which was filed on 21 Mar. 2013 and which is hereby incorporated by reference.

### TECHNICAL FIELD

The disclosure relates generally to payment processing, and more particularly, to processing a payment for services/goods using a telephone number, or the like.

### BACKGROUND ART

Typically, a medical provider is contractually bound to collect a co-payment (co-insurance payment) prior to a binding expectation of an insurance company to pay the remaining balance for the medical services. Although patients are not supposed to receive non-emergency medical care until they provide co-payment, in reality, patients are often seen and treated by the medical provider whether or not a co-payment is secured in advance. Frequently, the medical provider will ask for payment after providing the treatment, e.g., as the patient makes his/her next appointment. In some states, upwards of thirty percent of those payers do not make payment at that time or at any time in the future. This translates into substantial annual losses in revenue to the medical provider.

For non-emergency care, the medical service provider will frequently request co-payment when a patient registers at the provider's office. The patient often is provided the option of paying the co-payment by cash or check. Some providers have attempted to increase the number of payers by accepting payments via payment cards (e.g., a credit card, debit card, or the like). FIG. 1 shows an illustrative process for accepting a credit card payment according to the prior art. As illustrated, the debtor's (e.g., patient's) card issuer will provide payment to the provider via a payment system and add a charge/debit the debtor's account with the card issuer. In particular, the provider's cashier terminal can read the patient's payment card account number from the payment card, and send an authorization request to a banking/credit card company with which the patient has a relationship. The authorization request includes the payment card account number and the amount of the transaction, among other information. The authorization request is routed via a payment system to the issuer financial institution that issued the customer's payment card. Assuming that all is in order, the issuer transmits a favorable authorization response to the provider's cashier terminal.

Recently, mobile phone providers have started providing a direct carrier billing service, which allows their customers to pay for relatively small dollar transactions using their web enabled mobile devices, such as smart phones. In particular, a participating vendor can offer the consumer an option to pay for the goods/service by adding the charge to the consumer's bill from the mobile phone provider. To date, the vendors have primarily been online service providers and/or goods, such as app stores, music downloads, and/or the like. Subsequently, the transaction amount is added to the next bill from the mobile phone provider along with other charges for use of the mobile phone.

Various other mechanisms for requesting goods/services of various types and paying therefore are well known and established. For example, an individual purchasing gas can swipe a debit/credit card at the pump to initiate a charge. Similarly, another device, such as a key with an RFID chip or the like, can be used to identify the purchaser and initiate a charge with an associated credit/bank account. Some retailers offer layaway payment plans for goods, where the goods are set aside/reserved for the purchaser, who makes periodic payments towards the total cost of the goods. Once all payments are completed, the purchaser can receive the goods/services. Many goods/services, especially prepared food (e.g., take out or delivery) and items sold via television (e.g., an infomercial, commercial, shopping channel, and/or the like), are purchased over the telephone. In this case, the purchaser generally provides the payment information, such as a debit or credit card number to the retailer during the conversation.

### SUMMARY OF THE INVENTION

Aspects of the invention provide a solution for processing a transaction including a plurality of payments using a carrier for a mobile phone of a party to the transaction. Other aspects of the invention provide a solution for initiating payment, such as a carrier charge, for an item based on telephone identification information (e.g., a telephone number) of the purchaser.

Further aspects of the invention provide a solution for managing the provision of medical services/goods (e.g., registration, payment, reporting, and/or the like) using a carrier for a mobile phone of a party to the transaction (e.g., the patient or a payer for the patient).

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

A first aspect of the invention provides a system comprising: a computer system for managing a medical transaction at a medical provider by performing a method including: receiving telephone identification information corresponding to a payer for the medical transaction; and initiating a first partial payment for the medical transaction using the telephone identification information.

A second aspect of the invention provides a system comprising: a computer system for managing payment of a medical transaction by performing a method including: receiving, from a medical provider system corresponding to a medical provider of the medical transaction, data corresponding to the medical transaction, wherein the data includes a mobile identifier of a mobile device corresponding to a payer of the medical transaction, identification information of the medical provider, and an amount due prior to completing the medical transaction; providing, for processing on the mobile device associated with the mobile identifier, confirmation information regarding the medical transaction, the confirmation information including information corresponding to the medical provider and information corresponding to the amount due; receiving, from the mobile device, a response to the confirmation information; and initiating an action in response to the response received from the mobile device.

A third aspect of the invention provides a system comprising: a computer system for managing payment of a transaction by performing a method including: receiving, from a provider system corresponding to a provider of the transaction, data corresponding to the transaction, wherein the data includes a mobile identifier of a mobile device corresponding to a payer of the transaction, identification information of the provider, and an amount due for the transaction; providing, for processing on the mobile device associated with the mobile identifier, confirmation information regarding the transaction, the confirmation information including information corresponding to the provider and information corresponding to the amount due; receiving, from the mobile device, a response to the confirmation information; and initiating an action in response to the response received from the mobile device.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative process for accepting a credit card payment according to the prior art.

FIG. 2 shows an illustrative environment for processing a co-payment for goods/services according to an embodiment.

FIG. 3 shows an illustrative payment transaction according to an embodiment.

FIGS. 4A-4C show block diagrams of illustrative embodiments of the invention.

FIG. 5 shows an illustrative process for implementing a transaction according to an embodiment.

FIG. 6 shows an illustrative block diagram according to another embodiment of the invention.

FIG. 7 shows an illustrative block diagram according to still another embodiment of the invention.

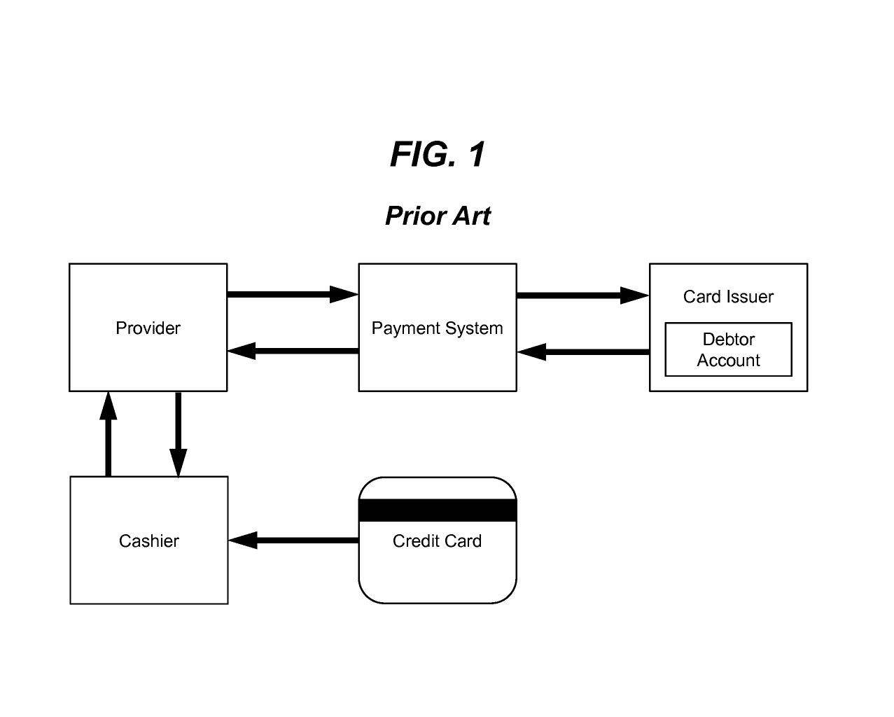

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for processing a transaction including a plurality of payments using a carrier for a mobile phone of a party to the transaction. Further aspects of the invention provide a solution for managing the provision of medical services/goods (e.g., registration, payment, reporting, and/or the like) using a carrier for a mobile phone of a party to the transaction (e.g., the patient or a payer for the patient). As used herein, unless otherwise noted, the term “set” means one or more (i.e., at least one) and the phrase “any solution” means any now known or later developed solution.

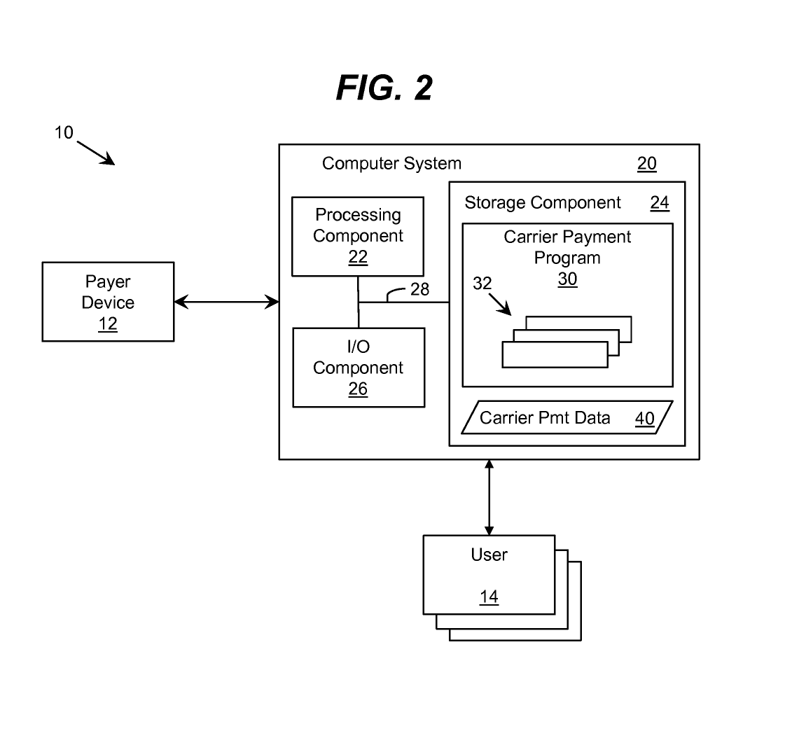

Turning to the drawings, FIG. 2 shows an illustrative environment 10 for processing a co-payment for goods/services according to an embodiment. To this extent, the environment 10 includes a computer system 20 that can perform a process described herein in order to process co-payments for goods/services. In particular, the computer system 20 is shown including a carrier payment program 30, which makes the computer system 20 operable to process co-payments for goods/services by performing a process described herein.

The computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, the processing component 22 executes program code, such as the carrier payment program 30, which is at least partially fixed in storage component 24. While executing program code, the processing component 22 can process data, which can result in reading and/or writing transformed data from/to the storage component 24 and/or the I/O component 26 for further processing. The pathway 28 provides a communications link between each of the components in the computer system 20. The I/O component 26 can comprise one or more human I/O devices, which enable a human user 12 to interact with the computer system 20 and/or one or more communications devices to enable a system user 12 to communicate with the computer system 20 using any type of communications link. To this extent, the carrier payment program 30 can manage a set of interfaces (e.g., graphical user interface(s), application program interface, and/or the like) that enable human and/or system users 12 to interact with the carrier payment program 30. Furthermore, the carrier payment program 30 can manage (e.g., store, retrieve, create, manipulate, organize, present, etc.) the data, such as carrier payment (pmt) data 40, using any solution.

In any event, the computer system 20 can comprise one or more general purpose computing articles of manufacture (e.g., computing devices) capable of executing program code, such as the carrier payment program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the carrier payment program 30 can be embodied as any combination of system software and/or application software.

Furthermore, the carrier payment program 30 can be implemented using a set of modules 32. In this case, a module 32 can enable the computer system 20 to perform a set of tasks used by the carrier payment program 30, and can be separately developed and/or implemented apart from other portions of the carrier payment program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 20.

When the computer system 20 comprises multiple computing devices, each computing device can have only a portion of the carrier payment program 30 fixed thereon (e.g., one or more modules 32). However, it is understood that the computer system 20 and the carrier payment program 30 are only representative of various possible equivalent computer systems that may perform a process described herein. To this extent, in other embodiments, the functionality provided by the computer system 20 and the carrier payment program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 20 includes multiple computing devices, the computing devices can communicate over any type of communications link. Furthermore, while performing a process described herein, the computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, the carrier payment program 30 enables the computer system 20 to process a payment, including a partial payment or co-payment, relating to a transaction, such as relating to medical services/goods provided by a provider.

Aspects of the invention provide a solution for receiving one of a plurality of payments for a service and/or good provided to an individual by a provider as part of a split payment transaction using direct carrier billing. For example, the provider and/or individual may have a contractual arrangement with a third party who will pay for an agreed upon portion of the service and/or good provided to the individual. In an illustrative embodiment described herein, the service and/or goods are medical (e.g., dental, pharmacy, health care, acupuncture, chiropractor, therapist, and/or the like) services and/or goods provided to the debtor or an individual for whom the debtor is paying for the medical services and/or goods. In this case, the payment received by the provider (e.g., a private office, a hospital, and/or the like) can comprise a co-payment and the third party can comprise an insurer or the like. Regardless, the provider can receive the payment from the debtor using a carrier corresponding to the debtor's mobile telephone.

Another embodiment provides a solution for a direct carrier to directly issue payment on behalf of its mobile phone customers for a split payment transaction and other payment transactions. In this case, the direct carrier can act as a paperless, card-less, mobile-based and mobile-billing banking entity, which provides a credit and/or debit account to customers, who receive statements/bills periodically (e.g., monthly) separate from their mobile phone bills. The direct carrier can provide the credit/debit account directly or act as an intermediary between the mobile customer and a banking institution. In either case, the mobile customer can pay for services/goods using his/her mobile phone or information corresponding to his/her mobile phone, which links to the mobile customer's credit/debit account with the mobile carrier, without requiring a debit or credit card.

A system described herein can cause payment transactions to be conducted in such a manner that the customer has additional choices, without compromising the known benefits of paying by cash or check. For example, an embodiment of the system can empower the customer by making him/her cognizant of all aspects of the transaction prior to initiation of authorization. Such a system can act as a deterrent to fraud and allows the customer (e.g., a patient) a voice and/or notification each time a charge is proposed.

An embodiment provides a solution for paying a co-payment for medical services including: providing co-payment transaction information for processing on a payer's mobile phone from a provider device (e.g., a hospital or other health care provider). The transaction information can include a payment amount and provider identifying information. The payer can generate a funds transfer request using his/her mobile phone. The funds transfer request can include the provider information, information indicating the transaction amount (e.g., the co-payment or a portion thereof), and information identifying a patient patron of the provider. The funds transfer request can be transmitted, from the mobile device, to the direct carrier along with the payer's digital signature. Subsequently, the carrier will pay the provider the transaction amount and add the transaction amount to the next mobile phone bill for the payer.

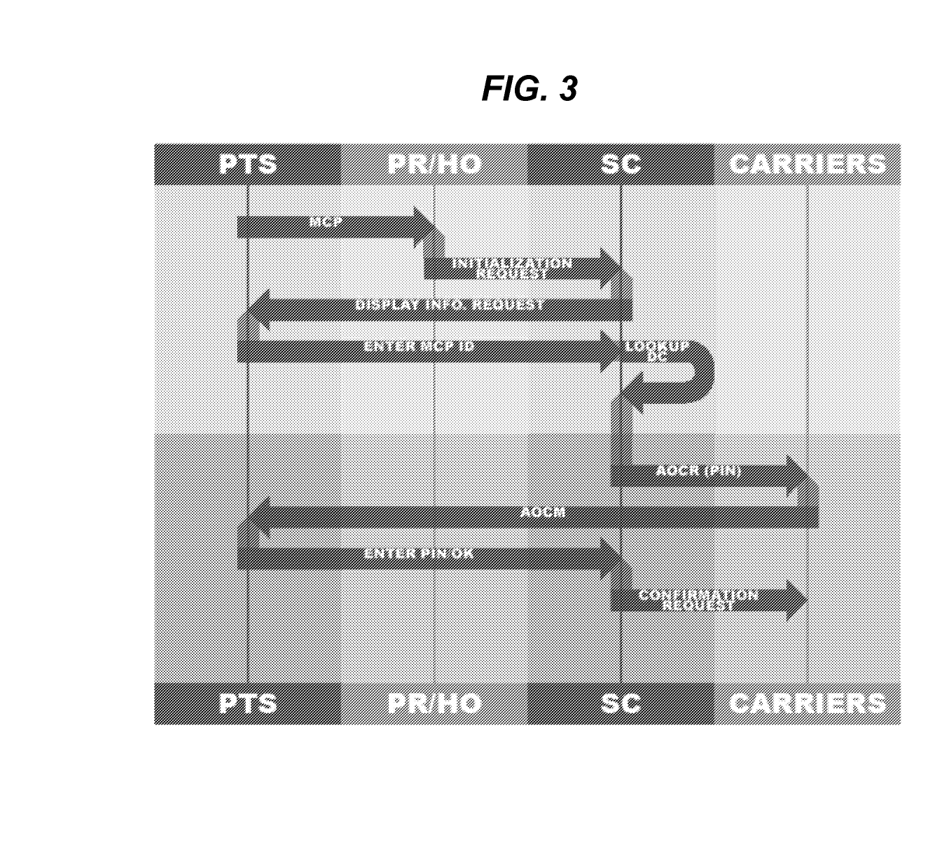

FIG. 3 shows an illustrative payment transaction according to an embodiment. In this case, the payment transaction is initiated from a patient's (PTS) mobile device and direct carrier billing is used to fulfill the co-payment obligation for the provider (PR/HO).

In an embodiment, the transaction information, such as an amount due for the co-payment, and a code that identifies the provider, can be displayed by the provider's designated web page (SC) (hereafter known as the provider's terminal) and transmitted to the patient's smartphone in the form of, for example, a text message. The provider's terminal can be a computer terminal that uploads the designated web page for the provider or a substantially equally functional mobile device (e.g., smart phone) or set of mobile devices in possession of multiple individuals (e.g., nurses or otherwise) authorized to receive payment. The text message(s) can include options that allow input by the patient, such as payment amount and willingness to pay by direct carrier billing. In the event that patient is unable to pay, the system can allow different options, including but not limited to, a reasonable monthly punitive surcharge (interest or other agreed upon charge a priori) on the patient's direct carrier billing.

In another embodiment, the payment request can direct the patient's mobile phone carrier to implement a transfer of funds to a provider account from any of the patient's authorized customer's bank accounts. In this case, the carrier, as an issuer of the customer's payment account or in its traditional telecommunications role, can respectively cause the payment transaction to be routed via the payment system route or direct carrier billing to the patient's monthly phone bill. Upon the patient's confirmation, the provider's office account would be accordingly either credited or charged. Upon completion of the payment, the direct carrier of the provider's office can send confirmation to the provider's office.

In this arrangement, the payment transaction using a carrier as a conventional credit dispensing company (but in a digital, cardless form) can access and/or procure funds for payment from any of the payer's banking accounts (accounts that a customer may have with, for example, a traditional banking company). Certain advantages of the rearranged and novel transaction flow described herein can increase efficiency, cost saving, uniformity of billing, billing/collection ratio, payment default, subsequent credit issues, and/or the like.

In an embodiment, a service provider can designate and operate a website, which can be designed for any type of provider that requires and/or accepts co-payments for the services and/or goods. In some configurations, embodiments of the invention can benefit a small office, e.g., a private office with only one or two doctors, or other healthcare professionals. A discrepancy in the low dollar amount of each individual co-payment transaction in contrast to expenses incurred with attempts to collect the co-payment often forces providers to write off losses from co-payments that are not received, which are often no more than twenty-five to fifty dollars per transaction.

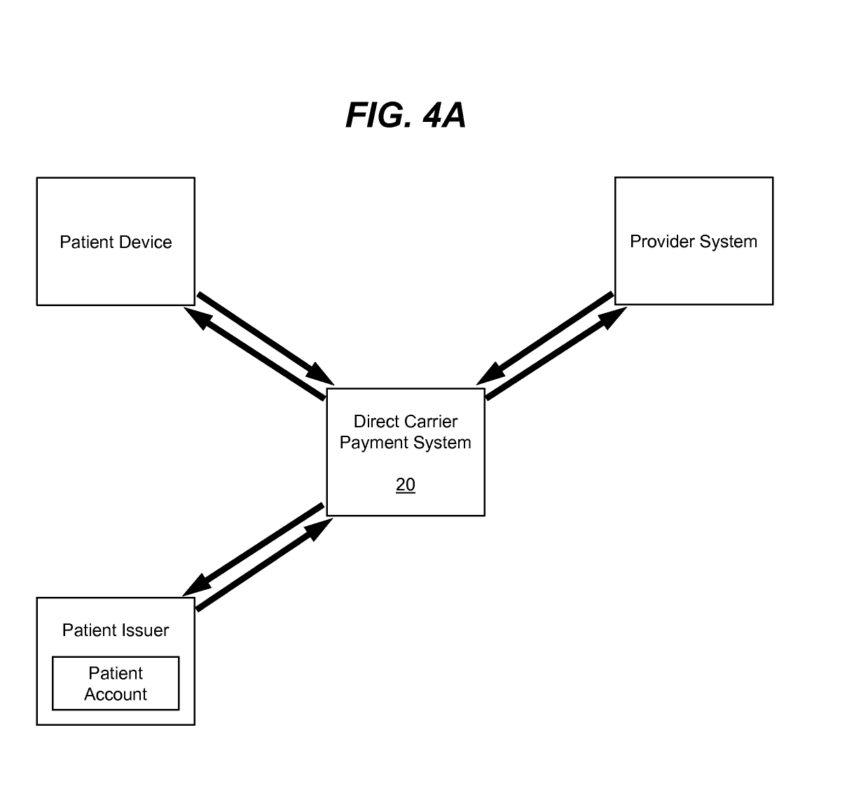

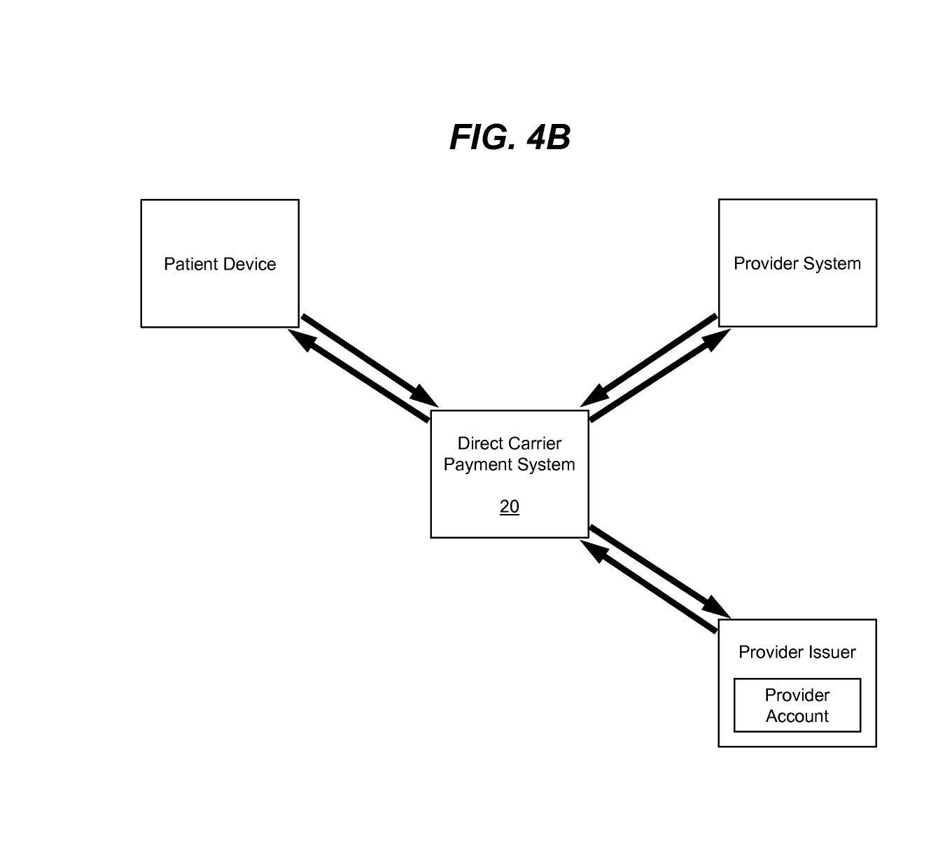

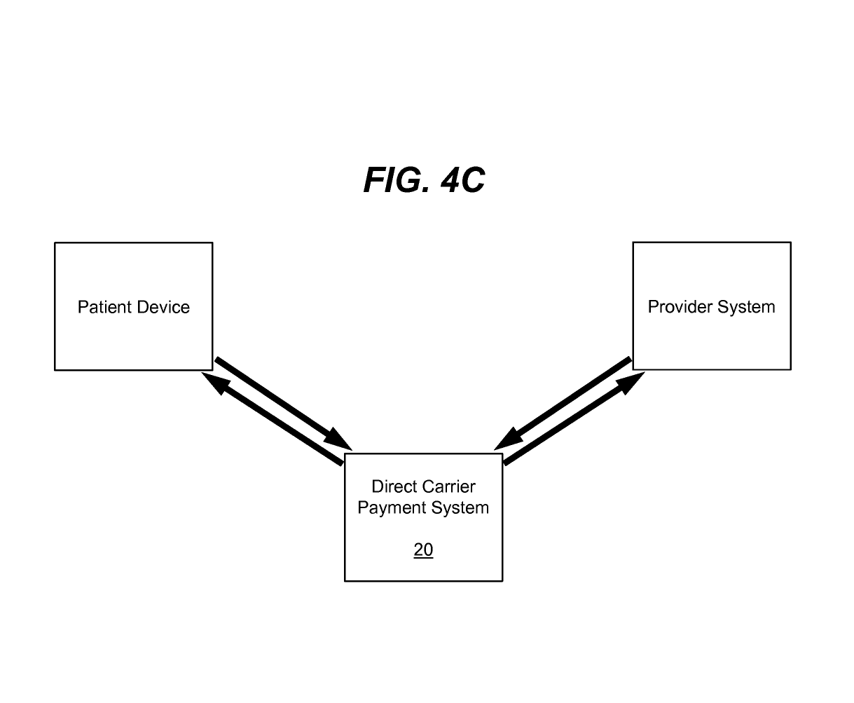

FIGS. 4A-4C show block diagrams of illustrative embodiments of the invention. In this case, a direct carrier payment system 20 can relay the payment transaction confirmation from a provider device to a patient device. To this extent, the carrier can act as an issuer of the patient (customer), of the provider (hospital), or both. As a result, the direct carrier payment system 10 can exchange communications between the provider device and the patient device, between either device and the issuer financial institution (such as the patient issuer), and/or the like.

In FIG. 4A, the patient or customer uses a traditional or non-carrier issuer (the patient issuer). In this example, the payment or fund transfer process can take place between the direct carrier payment system 20, which can act as the issuer of the provider, and the patient issuer acting on behalf of the patient/customer. The direct carrier payment system 20 can exchange communications between the provider system and the patient device and between the patient device and the patient's financial institution.

In FIG. 4B, the direct carrier payment system 20 acts as an issuer (e.g., credit dispensing institution) for the patient, while the provider uses a traditional, non-carrier issuer. In this example, the payment process takes place between the direct carrier payment system 20 acting as the issuer of the patient and the traditional, non-carrier, banking institution acting on behalf of hospital or merchant. The direct carrier payment system 20 can exchange communications between the provider system and the patient device, and between the provider system and the provider issuer (e.g., its financial institution).

In FIG. 4C, the direct carrier payment system 20 acts as an issuer for both the patient and the provider. In this example, the direct carrier payment system 20 acts as a full scale banking/credit issuing entity. A potential advantage of the architecture shown in FIG. 4C is that the direct carrier payment system 20 can effectively provide front end processing on behalf of the patient and the provider. This can make for a more frictionless payment process.

In each of the embodiments, the direct carrier payment system 20 can be a single carrier or two different carriers. In the latter case, the direct carrier payment system 20 can include an intermediary component, which manages the communications between the patient device, the provider system, the carrier(s), and the issuer(s) (when present). Furthermore, it is understood that while a patient/provider transaction is used as an illustrative financial transaction, aspects of the invention can be directed to any type of financial transaction between a purchaser and a merchant offering goods/services. Still further, it is understood that embodiments of the invention can include both the patient and the provider utilizing non-carrier issuers.

In an illustrative transaction implemented using one of the systems shown in FIGS. 4A-4C, a patient can initiate payment of a co-payment by orally providing his/her mobile telephone number (or other mobile identifier). A representative of the provider can enter the mobile telephone number (or other mobile identifier) into a webpage provided by the direct carrier payment system 20 as a prelude to the direct carrier payment system 20 transmitting the transaction data to the patient's mobile device, e.g., in the form of a text message or the like.

In an embodiment, the transaction data provided by the direct carrier payment system 20 can include identifying information for the provider (e.g., the name of the provider's office, hospital, or the like). In this case, the direct carrier payment system 20 can serve as a trusted third party verifying the identity of the provider, and thereby protecting the customer from dealing with an impostor, particularly with respect to office setting visits. Obtaining such identification information from the direct carrier payment system 20 can provide assurance to the patient that the provider has gone through an enrollment process with the direct carrier payment system 20 and is required to pay a nominal monthly fee to the direct carrier payment system 20 for managing security and efficacy of the designated provider page. In this way, the patient can be assured of the provider's identity before the patient approves the payment transaction.

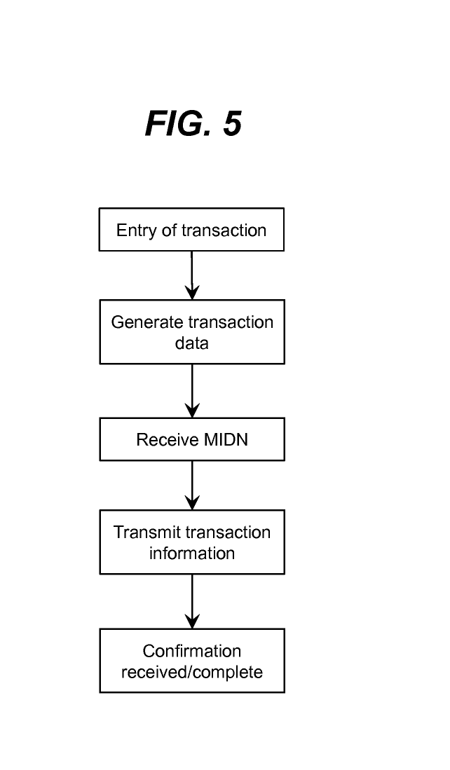

FIG. 5 shows an illustrative process for implementing a transaction according to an embodiment. In this case, the patient can enter a request for a payment transaction into his/her mobile device, which transmits the request to the direct carrier payment system 20. The provider can provide transaction information (e.g., the patient's mobile telephone number, an ICD code or an equivalent billing guideline, and/or the like) to the direct carrier payment system 20 (e.g., via a website). In response, the direct carrier payment system 20 can generate a payment amount for the transaction, such as a co-payment when the patient is insured. The direct carrier payment system 20 can send a message, such as a confirmation text, to the patient. Upon receiving a confirmation from the patient via his/her mobile telephone, the direct carrier payment system 20 can complete the transaction.

In an embodiment, the direct carrier payment system 20 can partially fund payment for a transaction (e.g., a portion of the co-payment) and another solution can be used to pay for the remainder of the transaction. For example, a patient can be provided an option to pay for a first portion of the co-payment with cash, a personal check, a credit/debit card, or the like, while the remainder of the co-payment is funded by the direct carrier payment system 20. The remainder of the co-payment can show up as a debit to an account of the patient's with the carrier, a charge that is added to the mobile phone bill or a credit account statement provided by the carrier to the patient, and/or the like.

As discussed herein, in connection with split-funding transactions, other than a co-payment, the direct carrier payment system 20 can perform, as a fully functional credit issuing institution, one or more of the following roles: a control agent for the transaction; a storage facility for capital, information, and/or logic used in mobile and online payments; a boutique, personalized credit and/or banking institution that can perform, per personalized instructions, and decide when and how split-funding should occur if the consumer/patient chooses to keep multiple traditional banking accounts; and as having the capacity to initiate two or more payment transactions, one as a traditional financial institution for the larger sum and the second by way of direct billing for co-payment.

In an embodiment, a customer's issuing financial institution, the provider, and/or the carrier can set one or more restrictions, which can be enforced by the direct carrier payment system 20. For example, with respect to a minor or an adult whose privileges are financed by a benefactor, in response to a request for a payment transaction of a kind that is not permitted by the noted authority (e.g., the parent, guardian, benefactor, or the like) over the mobile account, the direct carrier payment system 20 can send a real time inquiry message to the authority asking whether he/she will allow the requested transaction. With no approval, the requested payment transaction is declined. In this case, the child or other person who is in possession of the mobile phone can inform the authority ahead of time that he/she intends to request a co-payment transaction that falls outside the established restrictions. The authority can provide a pre-approval for the transaction to the direct carrier payment system 20 (e.g., via a web interface, mobile app, text message, and/or the like). In this manner, the direct carrier payment system 20 can retrieve a record of the transaction upon receiving the authorization response, and can provide a proper confirmation message to the provider device and/or the customer (e.g., patient) device.

In an embodiment, when the transaction is a medical transaction, the additional funding source can be a medical or dental insurance plan. In this case, the provider can use the direct carrier payment system 20 (e.g., via an assigned web page), to transmit an expected claim amount expected of the insurer as part of the transaction data provided to the direct carrier payment system 20. The direct carrier payment system 20 can enable the patient to provide authorization for an unpaid portion of the claim amount (e.g., for a payment rescinded or denied by the insurer, for payment required prior to the patient meeting an annual deductible, and/or the like) to be charged to/debited from the corresponding account of the patient (e.g., the mobile phone bill, a credit account, a financial account, and/or the like).

While aspects of the invention have been primarily described with reference to the medical, health care-related, and/or insured or insurable services, where a co-payment is often made, aspects of the invention are equally applicable for any payment transaction that can allow, in theory or practice, splitting a payment transaction between two (or more) payments or two or more payers. To this extent, the split can be in several portions by the same individual, at one time by two or more individuals, between an individual and a company or an institution, between an individual and a government, such as local, state, or federal medical payment systems (e.g., Medicare, Medicaid, and/or the like), and/or the like. To this extent, embodiments of the invention can be utilized in facilitating payment transactions by direct carrier billing or by using the carrier as a credit issuing company as described herein. In such embodiments, when split payments are involved, an embodiment of the invention can be used to settle payments for services such as car leasing payments, gym membership, sports and other entertainment tickets, travel fares, or any other product or service purchased with split or co-payments. Similarly, while aspects of the invention have been described in conjunction with transactions involving individuals, embodiments of the invention can be utilized for business-to-business transactions, wherein the direct carrier payment system 20 can be utilized by a business of any size as a one stop (banking) shop for making partial payments, payments, billing, marketing, communicating with, and/or the like, customers, banks and creditors. To this extent, as used herein, the term “co-payment” includes any payment transaction that involves partial payment by way of the direct carrier payment system 20.

In an embodiment, a payer can select to use the direct carrier payment system 20 by bringing his/her mobile device into proximity with a RFID/NFC (radiofrequency ID/near field communication) reading component of a provider's computer system. In response, the provider's system can perform the remaining transactional procedures using the direct carrier payment system 20, e.g., a designated web page. In another embodiment, the payer can receive a message containing the transaction information from the direct carrier payment system 20, which requires an affirmative response from the payer consenting for one or more subsequent steps to complete the payment. Following binding, an electronic signature requiring consent, additional messages, such as text messages, provided to the payer by the direct carrier payment system 20 can provide further guidelines for the payer regarding the transaction (e.g., a medical appointment).

In the event that payment is not received, the direct carrier payment system 20 can require that the payer agree to punitive charges or measures that can be taken. In this case, the direct carrier payment system 20 can charge nominal fees as an option that allows weekly or monthly billing to the carrier bill for the mobile phone owner until the agreed upon payments are resumed. This can help assure response from the payer and can protect the payer from unduly compromising his/her credit score. In an embodiment, the direct carrier payment system 20 can enable these options to be set by each individual provider to meet its unique expectations within the parameters of what is legally acceptable.

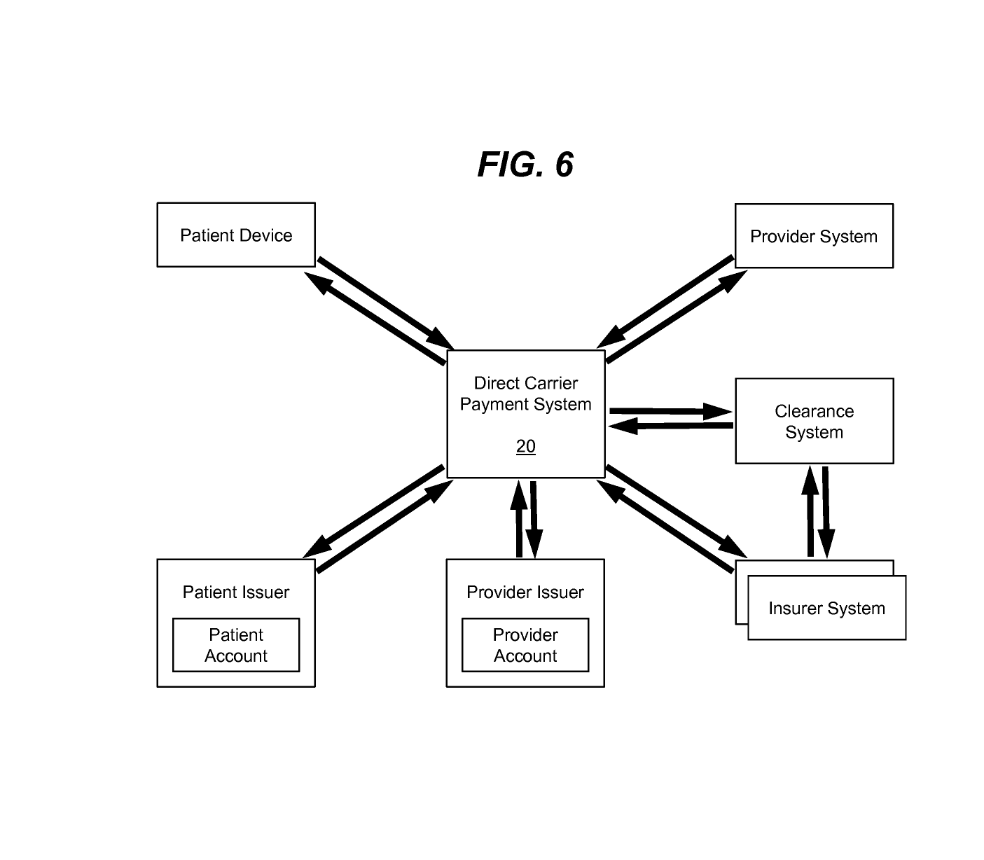

FIG. 6 shows an illustrative block diagram according to another embodiment of the invention. In this case, the direct carrier payment system 20 can act as an intermediary between the provider system and an insurer system and/or a clearance system in order to facilitate a transaction, such as a co-payment transaction for medical services/goods. In an illustrative transaction, the provider system can receive identification information for the patient device (e.g., a mobile phone number) using any solution (e.g., entered in a database, using a reader present at the provider's location, manual entry by an employee of the provider and/or the patient, and/or the like). The provider system also can obtain insurance information corresponding to the patient. In an embodiment, the patient device identification is used to look up the insurance information in a database of the provider. Alternatively, the insurance information can be obtained from an insurance card provided by the patient or using another solution. Additionally, the provider can confirm an identity of the individual possessing the mobile phone with an individual on record as owning the mobile phone using any solution (e.g., photo identification).

Regardless, the provider system can provide the mobile number, the insurance information, and/or a description of the goods/services to be provided for processing by the direct carrier payment system 20. The direct carrier payment system 20 can provide the insurance information to a clearance system, such as RelayHealth's RevRunner, which can evaluate the insurance eligibility, estimate patient financial responsibility, validate patient identity, and/or the like. In order to perform the evaluation, the clearance system can interface with one or more insurer systems to obtain current data for the individuals insured by the insurer(s). Regardless, the clearance system can return a result of the evaluation, which can include either that the insurance is no longer valid or information corresponding to the patient's responsibility for the services/goods. Such information can include a co-payment amount, a total amount (e.g., when the patient has a deductible that has not yet been met), and/or the like. Furthermore, the information can include information corresponding to one or more prerequisites required for the insurer to pay for the indicated services/goods.

Subsequently, the direct carrier payment system 20 can provide the information to the patient device and/or the provider system. For example, the direct carrier payment system 20 can send a request to the patient device asking for confirmation of the transaction and/or providing additional information regarding the transaction (e.g., an estimate of his/her total payment responsibility). Furthermore, the direct carrier payment system 20 can send a message to the provider system, e.g., indicating whether or not the insurance is valid, a total co-payment amount required, and/or the like.

In an embodiment, by utilizing the direct carrier payment system 20, the patient preauthorizes the direct carrier payment system 20 to charge the co-payment using a solution as described herein (e.g., by adding to a mobile phone bill, charging a credit/debit card, and/or the like) when the insurance information is valid. In this manner, for a returning patient, the provider merely needs to obtain the patient's mobile phone number (which can be done in an automated manner) in order to process the co-payment, including validating the patient's insurance information, prior to providing services/goods. Furthermore, use of the direct carrier payment system 20 can provide a third party verification that the co-payment was received, thereby reducing a number of claim denials issued by the insurer and streamlining the claims process between the provider and the insurer. Furthermore, by utilizing the clearance system, additional insurance coverage for the patient may be identified, which can be utilized to pay for the services/goods provided by the provider.

In an embodiment, the provider system can utilize the direct carrier payment system 20 to pre-verify insurance information for patients having scheduled appointments (e.g., for the next day, next week, and/or the like) through the use of the clearance system. In this case, the direct carrier payment system 20 can provide information regarding the scheduled appointment to the provider and/or the patient prior to his/her arrival (e.g., requirements for preparing for the appointment, payment requirements, pre-requisites, and/or the like). Such advanced information can reduce problems that can occur during the check in process, which can result in lower patient satisfaction with the provider. By using the direct carrier payment system 20, a provider can perform unlimited checks for insurance coverage throughout the revenue cycle on every patient encounter. By submitting the most current third party payment information available to an insurer, the provider can prevent claim denials and future re-work, improving cash flow.

Furthermore, an insurer can minimize abuse with respect to the number of visits made by a patient to a provider by insuring that his/her co-payment is paid each visit before paying the remaining balance. In an embodiment, the direct carrier payment system 20 can act as a third party verification service for the collection of co-payments from patients. In this case, an insurer can utilize payment information provided by the direct carrier payment system 20 to expedite the processing of the corresponding claims submitted by the provider over other claims where proof of the co-payment can be more difficult to ascertain. Furthermore, the direct carrier payment system 20 also can provide payment denial information for a patient, which can enable the insurer to flag a claim submitted by a provider for follow up regarding the fulfillment of the co-payment obligation.

In an embodiment, the direct carrier payment system 20 can manage various aspects relating to the provision of medical services/goods (e.g., registration, payment, reporting, and/or the like). For example, for previous patients, the direct carrier payment system 20 can manage confirmation of the appointment, transmission of pre-appointment instructions, pre-confirmation of the insurance information on record, and/or the like. In this case, the provider system can provide information corresponding to an appointment along with a mobile telephone number related to the patient. The direct carrier payment system 20 can manage communications with the patient or patient's guardian regarding the appointment. Should the patient/guardian desire to speak with an individual at the provider, the direct carrier payment system 20 can transmit such a request to the provider system.

Upon arrival of the patient at the provider's office, the patient/guardian can provide his/her mobile telephone number to the provider system (e.g., via RFID, a web page, orally, by calling/texting a number, and/or the like). In response, the provider system can provide the mobile telephone number and/or additional information regarding the appointment for processing by the direct carrier payment system 20. The direct carrier payment system 20 can confirm the insurance information and process the co-payment using a solution described herein. Additionally, the direct carrier payment system 20 can provide confirmation information and/or additional payment information to the patient device and/or the provider system.

When an insurer system provides real time information regarding the patient's payment obligations for use by the direct carrier payment system 20 and/or the clearance system, the provider can receive full payment (e.g., the co-payment as well as the remaining obligation for the patient) at the time of the appointment. For example, the co-payment can be received prior to the appointment, and the remaining payment can be invoiced/paid upon completion of the appointment. In exchange for being able to collect an increased percentage of co-payments and/or full payments at the time of providing a service, the provider can negotiate a lower rate with the insurer. In this manner, insurance costs can be reduced, provider overhead can be reduced, and the revenue received by the provider can be increased.

The direct carrier payment system 20 also can manage reporting between the provider and the insurer. The reporting can include, for example, information corresponding to the appointments confirmed through the direct carrier payment system 20, the co-payments received through the direct carrier payment system 20 (indicating that the services/goods were provide), the patient/insurer obligations for payment, and/or the like. Similarly, the direct carrier payment system 20 can manage reporting between the provider and a government oversight agency.

Furthermore, the direct carrier payment system 20 also can manage reporting between the insurer and the patient. For example, the direct carrier payment system 20 can provide the patient with information corresponding to his/her payment obligations based on different provider options (e.g., different drug stores, specialists, physicians, and/or the like). Using this information, the patient can make a cost-informed decision regarding the provider to use. Furthermore, the direct carrier payment system 20 can provide the patient with information corresponding to his/her remaining amount for a high deductible plan, expenses incurred year to date, an annual expense report, and/or the like. Such reporting information can be used by the patient to manage his/her medical savings account, complete income taxes, and/or the like. In an embodiment, when the patient utilizes a high deductible plan in conjunction with a medical savings account, the direct carrier payment system 20 can pay the patient's obligation for a qualifying medical expense directly from the patient's medical savings account (i.e., the patient issuer is the medical savings account).

While shown and described herein primarily with reference to a mobile device, it is understood that the direct carrier payment system 20 can utilize identifying information (e.g., a telephone number) for any type of telephonic device or access method associated with a patient. To this extent, the provider system can provide a home telephone number or the like, for processing by the direct carrier payment system 20. Similarly, the direct carrier payment system 20 can provide the mobile or other type of telephonic device number for processing by the clearance system and/or the insurer system, e.g., as a key value in order to obtain information regarding a patient associated with the telephone number. In this manner, the patient's identification information at the provider system, the insurer system, the patient issuer, and/or the like, is not shared with any of the other systems, and therefore is less susceptible to being improperly obtained and/or utilized.

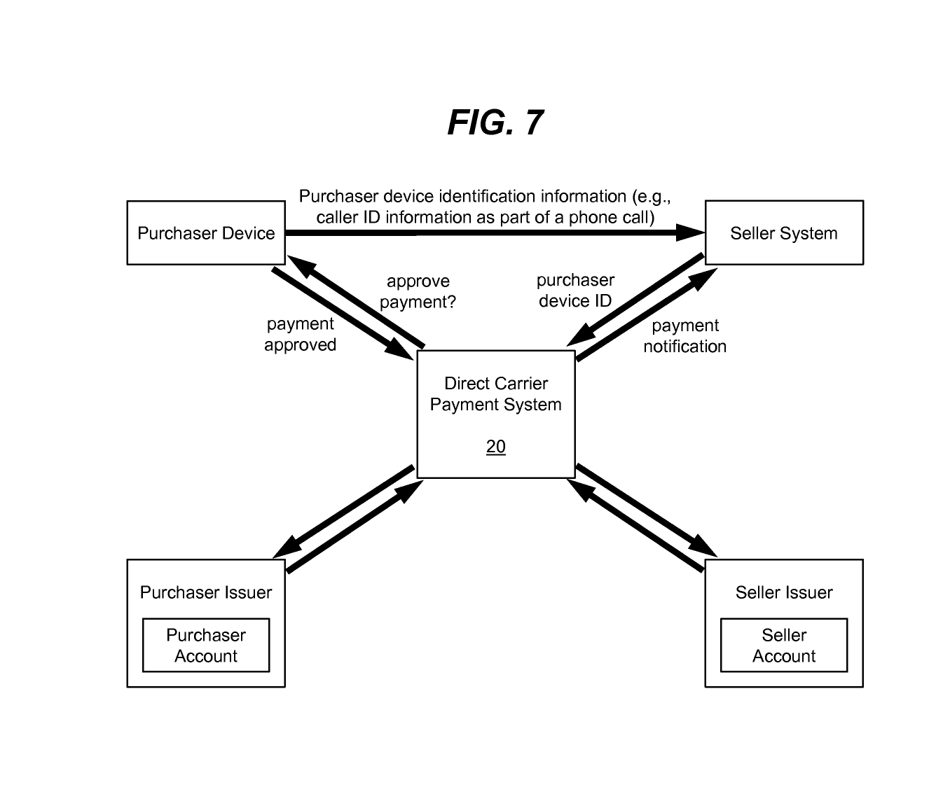

FIG. 7 shows an illustrative block diagram according to still another embodiment of the invention. In this case, each of the purchaser device and the seller system can include any type of telephonic device. Illustrative telephonic devices include, for example, a landline telephone, a mobile phone (including a smartphone), a voice over internet protocol (VoIP) device, and/or the like. Furthermore, the seller system can include one or more computing devices, which can acquire purchaser device identification information using any solution. For example, the purchaser device identification information can correspond to caller identification information for calls received by the seller system. The caller identification information can be acquired using any solution, e.g., when transmitted as part of a ringing signal transmission initiated by the purchaser device.

Alternatively, the purchaser device identification information can be obtained using a manual solution and/or without a telephone call. For example, the purchaser device identification information can be manually entered by a user of the seller system (e.g., copied from caller identification information provided to the user, and/or the like). When the purchaser device identification information is not acquired from information automatically acquired as part of a telephone call, the seller system can acquire the purchaser device identification information using any of various solutions, including entered from information provided by a purchaser during the telephone call (during which the purchaser could be using a different telephonic device), orally provided to the user of the seller system in person, provided by the purchaser using one or more data acquisition solutions, e.g., a keypad, an RFID reader, a website provided by the seller system, and/or the like.

In any event, the purchaser device identification information can be used to affect a payment transaction for the goods/services of the seller being purchased by the purchaser. To this extent, the seller system can provide the purchaser device identification information (or information corresponding thereto) along with a payment amount for processing by a direct carrier payment system 20. In an embodiment, the seller system automatically provides the purchaser device identification information to affect the payment transaction in response to the telephone call.

For example, the purchaser device can forward a payment request code along with the caller identification information during the initiation of the telephone call requesting that the purchaser device identification information be used for any required payment transaction. The payment request code can be generated by the purchaser device as part of initiating the telephone call in response to input from the user of the purchaser device, e.g., in response to a prompt provided to the user by the purchaser device, automatically, and/or the like.

In any event, the prompt and/or request code can be provided for each call placed using the purchaser device or only a subset of calls placed using the purchaser device. For example, the purchaser device can be configured to recognize a telephone number dialed during which a payment transaction was conducted, an address book entry on the purchaser device can flag telephone numbers for which the purchaser device identification information is to be used for payment transactions, and/or the like, in response to which the prompt can be generated and/or the payment request code can be automatically sent. In an embodiment, the prompt requires the user of the purchaser device to enter a security code (e.g., a pin, a spoken code, and/or the like) in order to authorize the initiation of a payment transaction during the telephone call.

Similarly, the purchaser device and the seller system can exchange payment transaction information as part of initiating a telephone call, during a telephone call, at the end of a telephone call, and/or the like. For example, in response to receiving a ring signal, the seller system can provide a code indicating that the seller system is configured to accept purchaser device identification information to affect payment for a transaction. Alternatively, during a telephone call (e.g., in response to a request from a user of the seller system), the seller system can temporarily interrupt a telephone call to complete a purchase transaction. In either case, in response to receiving a code from the seller system, the purchaser device can prompt the user as to whether such a payment transaction is desired, which can require entry of a security code, and provide a response to the seller system based on the user's response to the prompt. If known, the seller system also can provide a dollar amount for the transaction for confirmation by the purchaser. For transactions in which a tip may be included, the seller system can enable the purchaser to add a tip amount to the payment total.

Upon receiving the purchaser device identification information and payment amount, the direct carrier payment system 20 can use the purchaser device identification information to affect payment of the payment amount via a direct carrier billing solution described herein. In this case, the phone carrier can comprise any type of phone carrier, including a mobile phone carrier, a landline phone carrier, a VoIP carrier, and/or the like. As part of affecting the payment transaction, the direct carrier payment system 20 can send an approval request for the payment transaction for processing on the purchaser device or another device associated therewith (e.g., another telephonic device, a computing device, and/or the like). In response, the user of the purchaser device can provide a confirmation of the amount of the transaction. In response to receiving the confirmation, the direct carrier payment system 20 can complete the payment transaction. For example, the direct carrier payment system can manage communications with the purchaser issuer, the seller issuer, and/or the seller system. To this extent, once the payment transaction is complete, the direct carrier payment system 20 can provide a payment notification for processing by the seller system.

As described herein, the purchaser issuer can comprise a carrier for the purchaser device, a credit/banking institution having an account associated with the purchaser device identification information, and/or the like. When the purchaser issuer is the carrier for the purchaser device, the transaction amount can be added as an additional charge to the next regularly scheduled invoice sent by the carrier to the owner of the purchaser device. Similarly, when the credit/banking institution (which can comprise a carrier as described herein) is the purchaser issuer, an account of the purchaser can be debited by the transaction amount.

The process shown in FIG. 7 can be utilized for various types of purchases and transactions. For example, the purchaser device can be used to order an item or service during a telephone call. Illustrative services/goods include a mail order transaction, a shopping channel transaction, a service to be provided remotely or at a residence, a food order (e.g., such as an order for prepared food, or the like), and/or the like. In response to the transaction, the seller can: send an agent to perform the services/deliver the goods (e.g., a delivery food order), hold the goods to be picked up by the purchaser (e.g., a takeout food order), use a third party to deliver the goods to an address, and/or the like. In each case, the payment can be completed using the purchaser device identification information, thereby enabling the goods to be exchanged and/or the services to be provided without requiring the exchange of money or traditional payment information (e.g., a credit/debit card number). Such a transaction can have several benefits, including, enabling a child or other non-paying third party to pick up the goods, a delivery person can have less cash and/or not accept credit, a purchaser does not need cash on hand or provide credit card information over the telephone, and/or the like.

In another embodiment, the transaction can be performed as part of a multi-payment plan, such as a layaway agreement. In this case, a purchaser can set up the multi-payment plan at a store, at a website, and/or the like, using the purchaser device identification information to affect one or more of the payments. For example, the purchaser can provide the purchaser device identification information to the seller system using a solution described herein in order to affect a single payment or initialize a fixed number of recurring payments, each of which utilizes the purchaser device identification information. For each payment, the direct carrier payment system 20 can request an approval from the purchaser device prior to completing the payment transaction.

An embodiment also can be directed to other types of unattended transactions where tampering with a card reader is possible, e.g., a gas purchase, an ATM withdrawal, a movie rental, and/or the like. In this case, the seller system can be configured to obtain the purchaser device identification information, which initiates a payment transaction via the direct carrier payment system 20 as described herein.

Embodiments of the solution described herein can provide a more secure solution for affecting payment transactions. For example, when the purchaser is required to provide approval prior to the transaction being completed, the purchaser can immediately determine when a third party is attempting to make a payment using his/her purchaser device identification information and prevent the payment from being made. Furthermore, as the seller system only receives purchaser device identification information, there is no opportunity for an employee or another third party to obtain and/or utilize information corresponding to a bank/credit account of the purchaser. Still further, as individuals use their telephonic devices almost every day, a lost telephonic device can be determined earlier and action can be taken quickly to prevent the telephonic device from being utilized in an unauthorized manner to affect payments. Additionally, embodiments of the solution described herein can provide a more efficient solution for affecting payment transactions by enabling payments to be affected earlier in a transaction, in a semi-automated or automated manner, and/or the like.

While shown and described herein as a method and system for processing payments, including partial payments, for services/goods, it is understood that aspects of the invention further provide various alternative embodiments. For example, in one embodiment, the invention provides a computer program fixed in at least one computer-readable medium, which when executed, enables a computer system to process payments for services/goods. To this extent, the computer-readable medium includes program code, such as the carrier payment program 30 (FIG. 2), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as the carrier payment program 30 (FIG. 2), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for processing payments for services/goods. In this case, the generating can include configuring a computer system, such as the computer system 20 (FIG. 2), to implement the method of processing partial payments for services/goods. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system comprising:
a computer system for managing a medical transaction at a medical provider by performing a method including:
receiving telephone identification information corresponding to a payer for the medical transaction; and
initiating a first partial payment for the medical transaction using the telephone identification information.

2. The system of claim 1, wherein the first partial payment is one of: a co-payment for the medical transaction or a portion of the co-payment for the medical transaction.

3. The system of claim 1, wherein the telephone identification information comprises a telephone number of a mobile device, and wherein the initiating includes providing information relating to the partial payment for processing by a carrier corresponding to the mobile device.

4. The system of claim 3, the method further including receiving a confirmation from the carrier of completion of the partial payment.

5. The system of claim 1, wherein the telephone identification information comprises a telephone number of a mobile device, and wherein the initiating includes providing information relating to the partial payment for processing by the mobile device.

6. The system of claim 1, the method further including initiating a second partial payment for the transaction from a third party using the telephone identification information.

7. The system of claim 6, the method further including:
processing a first partial payment received from a first third party payer corresponding to the telephone identification information; and
processing a second partial payment received from a second third party payer.

8. The system of claim 1, wherein the computer system comprises a mobile device of an individual authorized to receive payment for the medical provider.

9. The system of claim 1, wherein the medical transaction is a scheduled medical transaction, and wherein the method further includes:
providing information regarding the medical transaction for processing by the mobile device a predetermined amount of time in advance of a scheduled time of the medical transaction;
providing information regarding an insurer of a patient scheduled to receive the medical transaction and information regarding the medical transaction for evaluation by a clearance system in response to the patient arriving for the scheduled medical transaction; and
receiving a result of the evaluation prior to the patient checking out, wherein the result includes a total payment obligation of the patient for the medical transaction.

10. A system comprising:
a computer system for managing payment of a medical transaction by performing a method including:
receiving, from a medical provider system corresponding to a medical provider of the medical transaction, data corresponding to the medical transaction, wherein the data includes a mobile identifier of a mobile device corresponding to a payer of the medical transaction, identification information of the medical provider, and an amount due prior to completing the medical transaction;
providing, for processing on the mobile device associated with the mobile identifier, confirmation information regarding the medical transaction, the confirmation information including information corresponding to the medical provider and information corresponding to the amount due;
receiving, from the mobile device, a response to the confirmation information; and
initiating an action in response to the response received from the mobile device.

11. The system of claim 10, wherein the response comprises an authorization for the medical transaction, and wherein the action comprises initiating a payment to the medical provider for the amount due.

12. The system of claim 11, wherein the initiating includes providing information regarding the medical transaction for processing by a patient issuer system, and wherein the method further includes:
receiving a response from the patient issuer system; and
providing an indication corresponding to payment for the medical transaction for processing by at least one of: the patient device or the medical provider system.

13. The system of claim 11, wherein the initiating includes debiting an account of the payer by the amount due, and wherein the method further includes:
providing information regarding a credit transaction for processing by a provider issuer system; and
providing an indication corresponding to payment for the medical transaction for processing by at least one of: the patient device or the medical provider system.

14. The system of claim 11, wherein the initiating includes debiting an account of the payer by the amount due, and wherein the method further includes:
crediting an account of the provider by the amount due; and
providing an indication corresponding to payment for the medical transaction for processing by at least one of: the patient device or the medical provider system.

15. The system of claim 10, wherein the method further includes receiving correspondence regarding an approval of the medical transaction from an authority corresponding to the mobile identifier, and wherein the initiating is further based on the approval correspondence.

16. The system of claim 10, wherein the method further includes providing expected claim information for processing by an insurer system, wherein the insurer system corresponds to an insurer of a patient associated with the mobile identifier, and wherein the expected claim information includes identification information of the medical provider, insurance information for a patient receiving the medical transaction, and an expected claim amount for the medical transaction.

17. The system of claim 16, wherein the method further includes:
receiving the insurance information for the patient from the medical provider system;
providing the insurance information for evaluation by a clearance system;
receiving a result of the evaluation and information regarding the insurance from the clearance system; and
providing information relating to the evaluation to at least one of: the mobile device or the provider system.

18. A system comprising:
a computer system for managing payment of a transaction by performing a method including:
receiving, from a provider system corresponding to a provider of the transaction, data corresponding to the transaction, wherein the data includes a mobile identifier of a mobile device corresponding to a payer of the transaction, identification information of the provider, and an amount due for the transaction;
providing, for processing on the mobile device associated with the mobile identifier, confirmation information regarding the transaction, the confirmation information including information corresponding to the provider and information corresponding to the amount due;
receiving, from the mobile device, a response to the confirmation information; and
initiating an action in response to the response received from the mobile device.

19. The system of claim 18, wherein the amount due corresponds to a portion of a total amount for the transaction for which the payer is responsible.

20. The system of claim 18, wherein the transaction is a non-medical transaction.
